(19) United States
(12) Patent Application Publication
(10) Pub. No.: US 2012/0157369 A1
(43) Pub. Date: Jun. 21, 2012

(54) WASHING PERFORMANCE USING POLYMERS CONTAINING AROMATIC GROUPS

(75) Inventors: Christian Kropf, Hilden (DE); Andreas Buhl, Langenfeld (DE); Benoit Luneau, Dusseldorf (DE); Christian Umbreit, Neuss (DE); André Hätzelt, Dusseldorf (DE)

(73) Assignee: Henkel AG & Co. KGaA, Dusseldorf (DE)

(21) Appl. No.: 13/403,149

(22) Filed: Feb. 23, 2012

Related U.S. Application Data
(63) Continuation of application No. PCT/EP2010/062376, filed on Aug. 25, 2010.

(30) Foreign Application Priority Data
Aug. 26, 2009 (DE) 10 2009 028 892.9

(51) Int. Cl. C11D 3/37; C08G 61/10; C08G 73/06; C08G 75/24

(52) U.S. Cl. 510/276; 562/89; 585/19; 546/152; 544/284; 544/180

(57) ABSTRACT

The present invention comprises polymers having optionally substituted aromatic residues in the polymer backbone and/or side chains, useful for the removal and/or dispersion of hydrophilic soils from textiles. The present invention also comprises a method for the removal of hydrophilic soils from textiles comprising the step of contacting the soil with a polymer that comprises optionally substituted aromatic residues in the backbone and/or side chains. The present inventive polymers and method are particularly useful in the context of washing or pretreatment agents that effectively remove red wine, fruit, vegetable, food product, or beverage stains from textiles.

### CROSS-REFERENCE TO RELATED APPLICATIONS

This application is a continuation of PCT Application Serial No. PCT/EP2010/062376, filed on Aug. 25, 2010, which claims priority under 35 U.S.C. §119 to 10 2009 028 892.9 (DE) filed on Aug. 26, 2009. The disclosures PCT/EP2010/062376 and DE 10 2009 028 892.9 are hereby incorporated by reference in their entirety.

### FIELD OF THE INVENTION

The present invention relates to polymers with aromatic groups and more particularly to a method for dispersing and/or removing hydrophilic soil, including soils comprising red- and/or blue-colored dyes, using polymers with aromatic groups.

### BACKGROUND OF THE INVENTION

While the formulation of powdered, bleach-containing washing and cleaning agents no longer presents any major problems today, the formulation of liquid, bleach-containing washing and cleaning agents having adequate stability continues to be problematic.

It is well known that liquid washing and cleaning agents that do not contain any bleaching agents are generally inadequate at removing bleachable stains.

These inadequate washing and cleaning agents include the bleach-free color-washing agents where the bleaching agent is omitted to protect the dyes in the textiles from being bleached.

In the absence of bleaching agent, stains that are normally removed by the bleaching agent (i.e. bleachable stains) are either intensified or made more difficult to remove after the washing process. What is believed to happen is the chemical reaction of certain dyes contained in the stains. Such deleterious reactions include polymerization of the dyes that comprise the stains.

Polymerizable dyes include those responsible for red- to blue-colored stains. The polymerizable substances are especially polyphenolic dyes, such as the anthocyanidins or anthocyanins. The stains may include red wine, fruit, or vegetable stains that contain red and/or blue dyes, and in particular, polyphenolic dyes such as those from the class of the anthocyanidins or anthocyanins. Also, the problematic stains may have been caused by food products or drinks that contain the corresponding dyes.

The use of certain polymers with aromatic groups in washing and cleaning agents has been described in the prior art. However, the prior art only teaches the use of polymers with aromatic groups to disperse hydrophobic soil or to scavenge free radicals and stabilize individual washing agent ingredients.

For example, EP1001010 discloses the use of styrene (co)polymers as radical traps in bleach-containing washing and cleaning agents for the purpose of stabilizing washing agent components present.

Also, US2007/0287651 discloses the use of (co)polymers with aromatic groups as radical traps in bleach-containing liquid washing and cleaning agents for stabilizing washing agent components contained in washing agents.

Lastly, WO2003/015906 and GB2385593 disclose the use of polymers with aromatic groups as dispersing agents for hydrophobic soil.

With that said, there is clearly an unmet need for new hydrophilic soil dispersants and a need for stable liquid washing or cleaning agents containing agents that are effective at dispersing and/or removing hydrophilic soils such as polymerizable dyes.

### SUMMARY OF THE INVENTION

It has now been surprisingly found that by adding polymers with aromatic groups to washing and cleaning agents, the cleaning performance of the washing or cleaning agent can be significantly improved with regard to red- to blue-colored stains. The use of polymers having aromatic groups in washing and cleaning agents for the purpose of dispersion and/or removal of hydrophilic soil has not been described previously in the prior art.

The present invention discloses the use of polymers with aromatic groups for the dispersion and/or removal of hydrophilic soil. In particular, the present invention is a method for the dispersion and/or removal of stains that contain hydrophilic dyes by subjecting the stained textiles to polymers having aromatic groups. Preferably the present method is effective on polymerizable dyes, including polyphenolic dyes such as the flavonoids, especially anthocyanidins or anthocyanins or oligomers of these compounds. The present method preferably takes place in the context of a washing or cleaning agent, in particular in a washing agent for textiles or a textile pretreatment agent. The stains are preferably red- to blue-colored stains such as red wine stains or stains from fruit or vegetables that contain red- to blue-colored dyes. Also, the polymers of the present invention may be used to remove stains made from food products or drinks that contain these types of dyes.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention is a method for the dispersion and/or removal of hydrophilic soil, in particular for the dispersion and/or removal of stains that contain hydrophilic dyes, by contacting stains with polymers having aromatic groups. The particular dyes dispersed and/or removed by the present method include the polymerizable dyes such as polyphenolic dyes. These include flavonoids, especially anthocyanidins, anthocyanins, or oligomers of these compounds. The present method preferably utilizes a washing or cleaning agent comprising a polymer having aromatic groups. Such washing or cleaning agents may be washing agents for textiles or textile pretreatment agents. The stains dispersed and/or removed by the present method include red- to blue-colored stains, such as stains that result from red wine, fruit, or vegetables that contain red- to blue-colored dyes. The stains dispersible or removable by the present method may also arise from food products or drinks that contain the red- to blue-colored dyes.

The term “red- to blue-colored stains” is to be understood herein as stains that can have a color anywhere within the color spectrum of from red to blue. Therefore, in addition to stains at the extreme ends of the spectrum of red to blue, stains in intermediate colors, in particular violet, lilac, purple, or pink, are also included in the definition, as well as stains that have a red, violet, lilac, purple, pink, or blue shade, without consisting entirely of this color. The above-mentioned colors may also be light or dark in intensity in each case. For example, possible stain coloring may be from light to dark red or from light to dark blue. The stains to be dispersed/removed according to the inventive method may have been caused by fruits or vegetables including, but not limited to, cherries, red grapes, pomegranate, chokeberries, plums, sea buckthorn, açai berries, red or blackcurrants, elderberries, blackberries, raspberries, blueberries, cranberries, strawberries, bilberries, red cabbage, blood orange, eggplant, black carrots, red-fleshed, blue-fleshed potatoes, and red onions.

Polymers with Aromatic Groups

The polymers with aromatic groups that may be incorporated into the method of the present invention include polymers in which the aromatic groups are localized exclusively in the backbone, exclusively in the side chains, or both in the backbone and in the various side chains of the polymer structure. The polymer may comprise a linear and/or branched arrangement of monomers.

The aromatic group of the polymer is preferably a group with 5 to 14, and in particular, 6 to 10 atoms, wherein the aromatic group can also contain one or more hetero atoms selected from O, S, and N. What is referred to herein as the “aromatic group” is not necessarily aromatic throughout the entire group structure. For example, the aromatic groups useful for the polymer may consist of more than one cyclic structure, wherein only one of the cyclic structures is aromatized. In a preferred embodiment, however, the aromatic group has an aromatic system throughout, regardless of the number of cyclic structures within the group.

According to the present invention, the aromatic groups are optionally substituted and preferably selected from the group consisting of benzene, naphthalene, anthracene, furan, thiophene, pyrrole, pyrazole, imidazole, oxazole, thiazole, isothiazole, phenanthracene, biphenyl, pyridine, pyridine-N-oxide, pyrimidine, pyrazine, triazine, pyrillium salts, thiopyrillium salts, quinoline, isoquinoline, indole, benzofuran, benzothiophene, benzimidazole, indazole, pyridofuran, pyridothiophene, and mixtures thereof. In a preferred embodiment, the optionally substituted aromatic residues comprise benzene, naphthalene, or mixtures thereof.

The aromatic groups may carry one or more, in particular one, two or three, substituents. The optionally present substituents of the aromatic groups are preferably selected from the group consisting of alkyl, (in particular C₁₋₆ alkyl), hydroxy, alkoxy, (in particular C₁₋₆ alkoxy), amino, alkylamino, (in particular C₁₋₆ alkylamino), dialkylamino, (in particular di-(C₁₋₆ alkyl)amino), amido, alkylamido, (in particular C₁₋₆ alkylamido), dialkylamido, (in particular di(C₁₋₆ alkyl)amido), halogen, (in particular fluorine, chlorine or bromine), hydrogencarbonyl, alkyl carbonyl, (in particular acetyl), alkoxycarbonyl, (in particular C₁₋₆ alkoxycarbonyl), oligooxyethylene, (in particular ethoxylate —(O—CH₂—CH₂—)ₙOH with n=1 to 20, especially 1 to 10), allyl, nitro, carboxy, sulfo, and mixtures thereof.

In a preferred embodiment, at least 10-30%, preferably at least 40-60%, particularly preferably at least 70-90% of the aromatic residues, in particular all of the aromatic residues of the polymer, carry at least one hydroxy group and/or at least one amino group and/or at least one acid group, preferably at least one carboxylate or sulfonate group, particularly preferably at least one sulfonate group.

In another preferred embodiment according to the invention, at least 10-30%, preferably at least 40-60%, particularly preferably at least 70-90% of the monomeric units, in particular all of the monomeric units of the polymer, carry at least one hydrophilic group, preferably selected from hydroxyl, amino, amido, oligooxyethylene, (in particular the ethoxylate chain —(O—CH₂—CH₂—)ₙOH with n=1 to 20, especially 1 to 10), carboxy, and sulfo. The hydrophilic group may be substituents on monomeric units with aromatic residues, in particular substituents directly on the aromatic residues themselves, or on monomeric units that do not carry any aromatic residues. As an example of the latter case, an amido group of acrylamide or methacrylamide may be present.

The aromatic groups can be linked in the polymer directly via covalent bonds to one another and/or with the backbone of the polymer and/or the linking can also take place via low molecular-weight residues, optionally containing hetero atoms, wherein the low molecular-weight residue preferably comprises up to 10 atoms, in particular up to 6 atoms. The low molecular-weight residue here is preferably selected from alkylene, (in particular C₁₋₆ alkylene, especially methylene or ethylene), carboxylic acid anhydride (—C(═O)—O—C(═O)—), carbonyl (—C(═O)—), carbonyloxy (—C(═O)—O—), oxy (—O—), oxycarbonyl (—O—C(═O)—), oxycarbonyloxy (—O—C(═O)—O—), —C(═O)—NR—, —NR—C(═O)—, —O—C(═O)—NR—, —NR—C(═O)—NR—, —NR— and —NRR′—, wherein R and R′, each independently of one another, are selected from hydrogen, methyl, ethyl, and propyl. The linking of the aromatic residues with one another and/or of the aromatic residues with the backbone can in this case take place within the polymer via one type of low molecular-weight residues or via various types of such residues, in particular of the kind referred to above.

Polymers in which the aromatic groups are localized in the backbone and linked together directly via covalent bonds include, but are not limited to, polyphenylene, polyquinoline, polyquinoxaline and polytriazine.

Polymers in which the aromatic groups are localized in the backbone of the polymer, and where methylene bridges provide the linking of the aromatic groups, include, but are not limited to, poly(naphthalenesulfonate), poly(naphthalenesulfonate-co-naphthalene), poly(naphthalenesulfonate-co-benzene), poly(naphthalenesulfonate-co-benzenesulfonate), poly(naphthalenesulfonate-co-toluene) and poly(naphthalenesulfonate-co-toluenesulfonate), poly(naphthalenesulfonate-co-xylene) and poly(naphthalenesulfonate-co-xylenesulfonate). Polymers in which the linking takes place via an anhydride bond include polyterephthalate optionally substituted by sulfonic acid groups.

Polymers in which the aromatic groups are localized in the side chain include any types of polymers known to one skilled in the art that are appropriately modified. These polymers include for example modified poly(meth)acrylates, poly(meth)acrylamides, polyurethanes, polysaccharides, polyureas, polyesters, polyethers, polyethyleneimines, and (co)polymers of other ethylenically unsaturated compounds. However, the above-mentioned polymers having aromatic groups in the backbone are also particularly suitable as the polymer.

The aromatic groups in this embodiment can be bonded to the polymer backbone via functional groups of the said polymers, for example via ester or carboxylic acid amide bonds onto the carboxyl group of poly(meth)acrylic acids or poly(meth)acrylamides. Otherwise, the aromatic groups can be bonded to the polymer backbone directly by covalent bonds and/or via the above-mentioned low molecular-weight residues, optionally containing hetero atoms. Ester, ester amide, ether, amine and imine bonds are preferred here. At least 10-40%, in particular at least 50-70%, particularly preferably at least 80-90%, especially at least 95-100% of the monomeric units of the polymer preferably carry an aromatic group.

In a preferred embodiment, the polymer with aromatic groups in the side chain comprises a poly(meth)acrylate or poly(meth)acrylamide, in which at least 10% of the acid or acid amide groups are modified by formation of an ester bond with hydroxy-substituted aromatic residues or by formation of an amide bond with amine-substituted aromatic residues. The hydroxy-substituted aromatic residue is preferably phenol or hydroxynaphthalene, optionally substituted by further residues. The amine-substituted aromatic residue here is preferably aniline or aminonaphthalene, optionally substituted by further residues.

At least 10-40%, in particular at least 50-70%, particularly preferably at least 80-90%, especially at least 95-100% of the acid or acid amide groups here are preferably modified by formation of an amide bond with amine-substituted aromatic residues and/or by formation of an ester bond with hydroxy-substituted aromatic residues.

In a particularly preferred embodiment, at least 50%, preferably at least 60 or 70%, particularly preferably at least 80 or 90%, in particular all of the aromatic residues here, in addition to the hydroxy group that forms the ester bond to the polymer backbone, or in addition to the amino group that forms the amide bond to the polymer backbone, carry at least one additional hydroxy group and/or amino group and/or acid group, preferably a carboxylate or sulfonate group, and particularly preferably a sulfonate group. Accordingly, it is particularly preferably phenyl or naphthyl, preferably naphthyl, substituted by at least one hydroxy group or by at least one amino group and by at least one sulfonate group.

In another preferred embodiment, the polymer according to the invention is a (co)polymer of optionally substituted styrene and/or optionally substituted vinylnaphthalene, wherein the proportion of styrene and/or vinylnaphthalene is at least 10-40%, in particular at least 50-70%, particularly preferably at least 80-90%, especially at least 95-98% or 100%. The other ethylenically unsaturated starting compounds of the polymer can be any compound known to the person skilled in the art. This can be in particular a C₁₋₆ alkylene, especially ethylene, propylene or butylene, acrylic acid, methacrylic acid, acrylamide or methacrylamide.

In a particular embodiment according to the invention, aromatic residues are localized both in the backbone of the polymer and in the side chains of the polymer. A preferred example is polyphenyl-polyphenylene. Also suitable as polymers of this kind are the above-mentioned polymers with aromatic groups in the backbone, which can in addition be modified by appropriate aromatic groups in the side chain.

In all of the above-mentioned special embodiments too, in a preferred embodiment in each case, at least 10, 20 or 30%, in particular at least 40, 50 or 60%, particularly preferably at least 70, 80 or 90% of the aromatic residues, in particular all of the aromatic residues of the respective polymer, carry at least one hydroxy group and/or at least one amino group and/or at least one acid group, preferably at least one carboxylate or sulfonate group, particularly preferably at least one sulfonate group.

Furthermore, also in all of the above-mentioned special embodiments, in another preferred embodiment at least 10, 20 or 30%, preferably at least 40, 50 or 60%, particularly preferably at least 70, 80 or 90% of the monomeric units, in particular all of the monomeric units of the polymer, carry at least one hydrophilic group, preferably selected from hydroxyl, amino, amido, oligo-oxyethylene, in particular —(OCH₂CH₂—)ₙOH with n=1 to 20, especially 1 to 10, carboxy, and sulfo.

The present invention also provides the polymers having aromatic groups as inventive chemical substances, which can be used in the method according to the invention, and in particular in washing and cleaning agents used for the present method.

The present invention preferably provides polymers having optionally substituted aromatic residues in the backbone and washing or cleaning agents containing these polymers, wherein the aromatic residues are linked together covalently and/or by low molecular-weight residues, the low molecular-weight residues being selected from C₂₋₆ alkylene, especially ethylene, carboxylic acid anhydride (—C(═O)—O—C(═O)—), carbonyl (—C(═O)—), carbonyloxy (—C(═O)—O—), oxy (—O—), oxycarbonyl (—O—C(═O)—), oxycarbonyloxy (—O—C(═O)—O—), —C(═O)—NR—, —NR—C(═O)—, —O—C(═O)—NR—, —NR—C(═O)—NR—, —NR— and —NRR′—, wherein R and R′ are selected in each case from hydrogen, methyl, ethyl and propyl. The aromatic residues and the optionally present substituents here are preferably selected from the above-mentioned groups. In a preferred embodiment here, at least 10, 20 or 30%, preferably at least 40, 50 or 60%, particularly preferably at least 70, 80 or 90% of the aromatic residues, in particular all of the aromatic residues, carry at least one hydroxy group and/or at least one amino group and/or at least one acid group, preferably at least one carboxylate or sulfonate group, particularly preferably at least one sulfonate group. In another preferred embodiment, at least 10, 20 or 30%, preferably at least 40, 50 or 60%, particularly preferably at least 70, 80 or 90% of the monomeric units, in particular all of the monomeric units of the polymers, carry at least one hydrophilic group, preferably selected from hydroxyl, amino, amido, oligooxyethylene, in particular —(O—CH₂—CH₂—)ₙOH with n=1 to 20, especially 1 to 10, carboxy and sulfo.

The present invention also preferably provides polymers having optionally substituted aromatic residues in the side chain and washing or cleaning agents containing these polymers, wherein the aromatic residues are linked with the backbone of the polymer covalently and/or by low molecular-weight residues, the low molecular-weight residues preferably being selected from alkylene, in particular C₁₋₆ alkylene, especially methylene or ethylene, carboxylic acid anhydride (—C(═O)—O—C(═O)—), carbonyl (—C(═O)—), carbonyloxy (—C(═O)—O—), oxy (—O—), oxycarbonyl (—O—C(═O)—), oxycarbonyloxy (—O—C(═O)—O—), —C(═O)—NR—, —NR—C(═O)—, (═O)—NR—, —NR—C(═O)—NR—, —NR— and —NRR′—, wherein R and R′ are selected in each case from hydrogen, methyl, ethyl and propyl. Particularly preferably, the aromatic residues are bonded to the backbone of the polymer via ester, ester amide, ether, amine, and/or imide bonds.

The aromatic residues and the substituents here are preferably selected from the above-mentioned groups. Preferably in this case at least 10, 20, 30 or 40%, in particular at least 50, 60 or 70%, particularly preferably at least 80, 85 or 90%, especially at least 95, 98 or 100% of the monomeric units of the polymer carry an aromatic group. In a preferred embodiment here, at least 10, 20 or 30%, preferably at least 40, 50 or 60%, particularly preferably at least 70, 80 or 90% of the aromatic residues, in particular all of the aromatic residues, carry at least one hydroxy group and/or at least one amino group and/or at least one acid group, preferably at least one carboxylate or sulfonate group, particularly preferably at least one sulfonate group. In another preferred embodiment, at least 10, 20 or 30%, preferably at least 40, 50 or 60%, particularly preferably at least 70, 80 or 90% of the monomeric units, in particular all of the monomeric units of the polymer, carry at least one hydrophilic group, preferably selected from hydroxyl, amino, amido, oligooxyethylene, in particular —(O—CH₂—CH₂—)ₙOH with n=1 to 20, especially 1 to 10, carboxy and sulfo.

Particularly preferred here are poly(meth)acrylates or poly(meth)acrylamides, in which at least 10% of the acid or acid amide groups are modified by formation of an ester bond with hydroxy-substituted aromatic residues or by formation of an amide bond with amine-substituted aromatic residues, the hydroxy-substituted aromatic residue preferably being phenol or hydroxynaphthalene, optionally substituted by further residues, and the amine-substituted aromatic residue is preferably aniline or aminonaphthalene, optionally substituted by further residues, the further residues preferably being selected from (further) hydroxy, (further) amino, carboxy and sulfo.

Particularly preferred are also (co)polymers of optionally substituted styrene and/or vinylnaphthalene, wherein the proportion of styrene and/or vinylnaphthalene in the resulting polymer is at least 10, 20, 30 or 40%, in particular at least 50, 60 or 70%, particularly preferably at least 80, 85 or 90%, especially at least 95, 98 or 100% and wherein the substituents are preferably selected from hydroxy, amino, carboxy and sulfo.

The molecular weight of polymers according to the invention is preferably from 1000 to 500,000 g/mol, particularly preferably from 1500 to 150,000 g/mol, especially from 2000 to 80,000 g/mol.

The polymers with aromatic groups are used according to the invention in a quantity of 0.01 to 10 wt. %, in particular in a quantity of 0.05 to 8 wt. %, particularly preferably in a quantity of 0.1 to 5 wt. %.

The washing or cleaning agent may be present in any form for use that is established according to the prior art. These include, for example, solid, powdered, liquid, gel or paste forms of administration, optionally also comprising several phases, compressed or non-compressed; they also include, for example: extrudates, granules, tablets or pouches, both in bulk containers and packaged in individual doses.

The method according to the invention preferably comprises a washing or cleaning agent that contains no bleaching agents. This is preferably understood according to the invention to mean that, as well as bleaching agents in the narrower sense, i.e. as well as hydrogen peroxide or substances providing hydrogen peroxide, the agent according to the invention also contains no bleach activators and/or bleach catalysts.

In another embodiment of the washing or cleaning agent according to the invention, bleaching agents, and in particular bleach activators and/or bleach catalysts, can also be included.

The washing or cleaning agent according to the invention in a particularly preferred embodiment is a liquid washing agent for textiles.

The washing or cleaning agent according to the invention in another particularly preferred embodiment is a powdered color-washing agent, i.e. a powdered textile-washing agent for colored textiles.

The washing or cleaning agent according to the invention in another particularly preferred embodiment is a textile pretreatment agent, i.e. an agent which is applied onto the stains before the actual washing process.

The washing agent for textiles according to the invention and the washing and cleaning agents in which the method according to the invention takes place can additionally contain other conventional components of washing and cleaning agents, in particular washing agents for textiles, in particular selected from the group of the builders, surfactants, polymers, enzymes, fabric-softening substances, in particular esterquats, protein hydrolyzates, electrolytes, pH regulators, fluorescent agents, hydrotopes, foam inhibitors, silicone oils, anti-redeposition agents, optical brighteners, graying inhibitors, shrinkage preventers, anti-crease agents, dye transfer inhibitors, active antimicrobial substances, germicides, fungicides, antioxidants, antistatic agents, ironing aids, proofing and impregnating agents, swelling and anti-slip agents, UV absorbers, disintegrants, perfumes, dyes and perfume carriers.

As exemplary builders, zeolites, silicates, carbonates, organic co-builders and/or phosphates may be used according to the invention.

As surfactants, in particular nonionic, anionic, cationic and/or amphoteric surfactants can be used according to the invention.

As enzymes, in particular proteases, amylases, lipases, hemicellulases, cellulases, perhydrolases and/or oxidoreductases can be used according to the invention.

### EXEMPLARY EMBODIMENTS

### Example 1

### Use of Sodium Polynaphthalenesulfonate (PNS) for Improving Washing Performance

Washing tests were carried out on 6 different stains, which are based on polyphenolic natural dyes (flavonoids). For the stains, extracts of cherries, blackcurrants, bilberries, blackberries, red grapes and red wine were used. The stain production took place mechanically by measuring out a constant quantity of a dilute aqueous solution of the extracts onto cotton fabric and subsequent drying. For the washing tests, a commercial liquid washing agent (LWA) was used and washing was performed at 40° C. in a conventional textiles washing machine at 16° dH water hardness. Five determinations were carried out and then the average was determined in each case. 75 g of the washing agent was measured out in each case. Before washing, pre-treatment of the stains was carried out by spraying 1 ml of a 2 wt. % aqueous solution of sodium polynaphthalenesulfonate (available from Handy Chemicals) onto the stains together with subsequent drying at RT. In addition, a quantity of 1.7 g sodium polynaphthalenesulfonate was added to the washing agent on top.

The evaluation took place by means of color distance measurement according to the Lab values and the Y values calculated therefrom as a measure of lightness. TABLE 1 shows the dY values, which are obtained from the difference Y (after washing)−Y (before washing), for the 6 above-mentioned stains.

TABLE 1
Destaining performance of sodium polynaphthalene sulfonate
(PNS)

| | | | | | Red | Red |
|---|---|---|---|---|---|---|
| dY values | Cherry | Blackcurrant | Bilberry | Blackberry | grape | wine |
| LWA only | 35.7 | 50 | 27.6 | 30.5 | 52.8 | 40.6 |
| LWA + PNS | 40.3 | 55.6 | 33.4 | 34.8 | 59 | 44.8 |

The results in TABLE 1 show that the dY values with pre-treatment+washing with PNS (bottom row) are greater than with the only LWA for each of the stains, which corresponds to a higher degree of whiteness and thus improved stain removal.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A hydrophilic soil dispersant comprising a polymer with backbone and side chains, said polymer consisting essentially of optionally substituted aromatic residues localized in the backbone of said polymer, wherein the aromatic residues are linked directly together by covalent bonds, and wherein said optionally substituted aromatic residues are selected from the group consisting of benzene, naphthalene, anthracene, furan, thiophene, pyrrole, pyrazole, imidazole, oxazole, thiazole, isothiazole, phenanthracene, biphenyl, pyridine, pyridine-N-oxide, pyrimidine, pyrazine, triazine, pyrillium salts, thiopyrillium salts, quinoline, isoquinoline, indole, benzofuran, benzothiophene, benzimidazole, indazole, pyridofuran, pyridothiophene, and mixtures thereof.

2. The dispersant of claim 1, wherein said polymer is selected from the group of optionally substituted polyphenylene, polyquinolines, polyquinoxalines, and polytriazines.

3. A hydrophilic soil dispersant comprising a polymer with backbone and side chains, said polymer comprising optionally substituted aromatic residues localized in the backbone of said polymer, wherein the aromatic residues are linked by low molecular-weight residues selected from the group consisting of C₂-C₆ alkylene, —C(═O)—O—C(═O)—, —C(═O)—, —C(═O)—O—, —O—, —O—C(═O)—, —C(═O)—NR—, —NR—C(═O)—, —O—C(═O)—NR—, —NR—C(═O)—NR—, —NR—, —NRR′—, and mixtures thereof, and wherein R and R′, if present, are independently selected from hydrogen, methyl, ethyl, and propyl.

4. The dispersant of claim 3, wherein said optionally substituted aromatic residues are selected from the group consisting of benzene, naphthalene, anthracene, furan, thiophene, pyrrole, pyrazole, imidazole, oxazole, thiazole, isothiazole, phenanthracene, biphenyl, pyridine, pyridine-N-oxide, pyrimidine, pyrazine, triazine, pyrillium salts, thiopyrillium salts, quinoline, isoquinoline, indole, benzofuran, benzothiophene, benzimidazole, indazole, pyridofuran and pyridothiophene, and wherein said optional substitution is selected from the group consisting of alkyl, hydroxy, alkoxy, amino, alkylamino, dialkylamino, amido, alkylamido, dialkylamido, halogen, hydrogencarbonyl, alkylcarbonyl, allyl, nitro, carboxy, alkoxycarbonyl, sulfo, and mixtures thereof.

5. The dispersant of claim 3, wherein at least 10% of said optionally substituted aromatic residues carry at least one substituent selected from hydroxyl, amino, and acid groups as the optional substitution.

6. The dispersant of claim 5, wherein all of said aromatic groups carry at least one substituent selected from hydroxyl, amino, and acid groups.

7. The dispersant of claim 6, wherein all of said aromatic groups carry at least one carboxylate or sulfonate group.

8. A hydrophilic soil dispersant comprising a polymer with backbone and side chains, said polymer comprising optionally substituted aromatic residues in said side chains, wherein the aromatic residues are directly covalently linked to the polymer backbone.

9. A hydrophilic soil dispersant comprising a polymer with backbone and side chains, said polymer comprising optionally substituted aromatic residues in said side chains, wherein the aromatic residues are linked to the polymer backbone by low molecular-weight residues selected from the groups consisting of C₁-C₆ alkylene, —C(═O)—O—C(═O)—, —C(═O)—, —C(═O)—O—, —O—, —O—C(═O)—, —O—C(═O)—O, —C(═O)—NR—, —NR—C(═O)—, —O—C(═O)—NR—, —NR—C(═O)—NR—, —NR—, —NRR′—, and mixtures thereof, and wherein R and R′, if present, are selected independently from hydrogen, methyl, ethyl, and propyl.

10. The dispersant of claim 9, wherein said linkages comprise ester, ester amide, ether, amine, or imide bonds.

11. A washing agent, cleaning agent, or textile stain pretreatment agent comprising a polymer with backbone and side chains, said polymer consisting essentially of optionally substituted aromatic residues localized in the backbone of said polymer, wherein the aromatic residues are linked directly together by covalent bonds, and wherein said optionally substituted aromatic residues are selected from the group consisting of benzene, naphthalene, anthracene, furan, thiophene, pyrrole, pyrazole, imidazole, oxazole, thiazole, isothiazole, phenanthracene, biphenyl, pyridine, pyridine-N-oxide, pyrimidine, pyrazine, triazine, pyrillium salts, thiopyrillium salts, quinoline, isoquinoline, indole, benzofuran, benzothiophene, benzimidazole, indazole, pyridofuran, pyridothiophene, and mixtures thereof.

12. A washing agent, cleaning agent, or textile pretreatment agent comprising a polymer with backbone and side chains, said polymer comprising optionally substituted aromatic residues localized in the backbone of said polymer, wherein the aromatic residues are linked by low molecular-weight residues selected from the group consisting of C₂-C₆ alkylene, —C(═O)—O—C(═O)—, —C(═O)—, —C(═O)—O—, —O—, —O—C(═O)—, —O—C(═O)—O—, —C(═O)—NR—, —NR—C(═O)—, —O—C(═O)—NR—, —NR—C(═O)—NR—, —NR—, —NRR′—, and mixtures thereof, and wherein R and R′, if present, are independently selected from hydrogen, methyl, ethyl, and propyl.

13. A method for the removal or dispersion of hydrophilic soils from textiles, said soils containing hydrophilic dyes, said method comprising the step of:
a. contacting said soil with a hydrophilic soil dispersant comprising a polymer with backbone and side chains, said polymer consisting essentially of optionally substituted aromatic residues localized in the backbone of said polymer, wherein the aromatic residues are linked directly together by covalent bonds, and wherein said optionally substituted aromatic residues are selected from the group consisting of benzene, naphthalene, anthracene, furan, thiophene, pyrrole, pyrazole, imidazole, oxazole, thiazole, isothiazole, phenanthracene, biphenyl, pyridine, pyridine-N-oxide, pyrimidine, pyrazine, triazine, pyrillium salts, thiopyrillium salts, quinoline, isoquinoline, indole, benzofuran, benzothiophene, benzimidazole, indazole, pyridofuran, pyridothiophene, and mixtures thereof.

14. The method of claim 13, wherein said soils comprise polyphenolic stains delivered onto the textile from exposure to red wine, fruit, vegetables, food products, or beverages.

15. A method for the removal or dispersion of hydrophilic soils from textiles, said soils containing hydrophilic dyes, said method comprising the step of:
a. contacting said soil with a hydrophilic soil dispersant comprising a polymer with backbone and side chains, said polymer comprising optionally substituted aromatic residues localized in the backbone of said polymer, wherein the aromatic residues are linked by low molecular-weight residues selected from the group consisting of C₂-C₆ alkylene, —C(═O)—O—C(═O)—, —C(═O)—, —C(═O)—O—, —O—, —O—C(═O)—, —C(═O)—NR—, —NR—C(═O)—, —O—C(═O)—NR—, —NR—C(═O)—NR—, —NR—, —NRR′—, and mixtures thereof, and wherein R and R′, if present, are independently selected from hydrogen, methyl, ethyl, and propyl.

16. The method of claim 15, wherein said soils comprise polyphenolic stains delivered onto the textile from exposure to red wine, fruit, vegetables, food products, or beverages.
